(19) United States
(12) Patent Application Publication
(10) Pub. No.: US 2025/0173080 A1
(43) Pub. Date: May 29, 2025

(54) INTERNAL MEMORY RECLAIMING METHOD, COMPUTER DEVICE, MEDIUM, AND PROGRAM PRODUCT

(71) Applicant: TENCENT TECHNOLOGY (SHENZHEN) COMPANY LIMITED, Shenzhen (CN)

(72) Inventors: Jingxiang ZENG, Shenzhen (CN); Kairui SONG, Shenzhen (CN); Yushan ZHOU, Shenzhen (CN); Kaixu XIA, Shenzhen (CN)

(73) Assignee: TENCENT TECHNOLOGY (SHENZHEN) COMPANY LIMITED, Shenzhen (CN)

(21) Appl. No.: 19/039,896

(22) Filed: Jan. 29, 2025

Related U.S. Application Data
(63) Continuation of application No. PCT/CN2023/131716, filed on Nov. 15, 2023.

(30) Foreign Application Priority Data
Jan. 18, 2023 (CN) 202310125014.5

(51) Int. Cl. G06F 3/06

(52) U.S. Cl. CPC G06F 3/0644; G06F 3/0608; G06F 3/0646; G06F 3/0683

(57) ABSTRACT

An internal memory reclaiming method, performed by a computer device that comprises at least two groups of SWAP devices, comprising: determining page access frequency information of an internal memory page to be reclaimed based on receiving an internal memory reclaiming instruction; determining a target SWAP device from the at least two groups of SWAP devices based on the page access frequency information; and transferring content data stored in the internal memory page to the target SWAP device.

### CROSS-REFERENCE TO RELATED APPLICATIONS

This application is a continuation application of International Application No. PCT/CN2023/131716 filed on Nov. 15, 2023, which claims priority to Chinese Patent Application No. 202310125014.5 filed with the China National Intellectual Property Administration on Jan. 18, 2023, the disclosures of each being incorporated by reference herein in their entireties.

### FIELD

The disclosure relates to the field of cloud technologies, and in particular, to an internal memory reclaiming method, a computer device, a medium, and a program product.

### BACKGROUND

In the related art, the operating system of the computer device may map virtual addresses of different processes to physical addresses of different pieces of internal memory. When a large quantity of processes are enabled during operation of the computer device, the operating system may remove content data in infrequently used physical internal memory from the physical internal memory through the internal memory swapping technology, and temporarily store the content data in a SWAP (swap partition) device. This process is also referred to as swap-out. The content data may be installed back into the physical internal memory when needed, and this process is also referred to as swap-in.

The operating system sorts content data stored in pages that need to be swapped out in a hot and cold order based on access frequencies of the pages. When all of the physical internal memory of the computer device is occupied, or the system internal memory is insufficient, the operating system may move content data of a page with a low access frequency down to the SWAP device based on the cold and hot order. When there are a plurality of SWAP devices, the operating system preferentially swaps out the content data of the page to a SWAP device with the highest priority.

However, a manner of selecting the SWAP device in the related art easily leads to a low utilization rate of the SWAP device in the computer system.

### SUMMARY

Provided are an internal memory reclaiming method, apparatus, and a non-transitory computer-readable storage medium, which improve memory management efficiency by determining target SWAP devices for memory page reclamation based on page access frequency information and other properties.

According to some embodiments, an internal memory reclaiming method, performed by a computer device comprising at least two groups of SWAP devices, includes: determining page access frequency information of an internal memory page to be reclaimed based on an internal memory reclaiming instruction; selecting a target SWAP device from the at least two groups of SWAP devices based on page access frequency information and device speed indication information; and transferring content data stored in the internal memory page to the selected target SWAP device. Additional steps include caching the content data in a buffer storage area associated with the target SWAP device and transferring the data when the cache exceeds its capacity.

According to some embodiments, an internal memory reclaiming apparatus comprises: at least one memory configured to store computer program code; and at least one processor configured to execute the program code, including: determining code to identify page access frequency information and a target SWAP device; and transferring code to transfer content data to the target SWAP device.

According to some embodiments, a non-transitory computer-readable storage medium stores computer code which, when executed by at least one processor, causes the processor to: determine page access frequency information of an internal memory page to be reclaimed and select a target SWAP device based on page access frequency and device speed; and transfer content data from the internal memory page to the target SWAP device.

### BRIEF DESCRIPTION OF THE DRAWINGS

To describe the technical solutions of some embodiments of this disclosure more clearly, the following briefly introduces the accompanying drawings required for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a block diagram of a structure of a system architecture according to some embodiments;

FIG. 2 is a schematic diagram of an internal memory reclaiming method according to some embodiments;

FIG. 3 is a flowchart of an internal memory reclaiming method according to some embodiments;

FIG. 4 is a flowchart of an internal memory reclaiming method according to some embodiments;

FIG. 5 is a flowchart of an internal memory reclaiming method according to some embodiments;

FIG. 6 is a schematic diagram of a SWAP device according to some embodiments;

FIG. 7 is a schematic diagram of an internal memory reclaiming method according to some embodiments;

FIG. 8 is a schematic diagram of a buffer storage area according to some embodiments;

FIG. 9 is a flowchart of an internal memory reclaiming method according to some embodiments;

FIG. 10 is a flowchart of an internal memory reclaiming method according to some embodiments;

FIG. 11 is a schematic diagram of an internal memory reclaiming method according to some embodiments;

FIG. 12 is a schematic diagram of an internal memory reclaiming method according to some embodiments;

FIG. 13 is a block diagram of a structure of a computer device according to some embodiments; and

FIG. 14 is a block diagram of a structure of a computer device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

First, terms involved in embodiments are briefly introduced.

Internal memory: an important part of the computer device, also referred to as a built-in memory and a main memory. The internal memory may be used for temporarily storing operation data in a central processing unit (CPU) and data that may be exchanged with an external memory such as hard disk. The internal memory includes physical internal memory and virtual internal memory.

SWAP device: being used for storing content data swapped out from the physical internal memory. For example, when internal memory of a computer device is insufficient, the operating system may swap out temporarily unused content data in the internal memory to the SWAP device, thereby freeing up internal memory for a currently running program. The SWAP device may be also referred to as a swap partition device.

Internal memory page: referring to a dynamically allocated data page of a heap and a stack when a process of a computer system is running.

Swap-out: referring to a process in which when the operating system enables a large quantity of processes, the operating system of the computer temporarily stores infrequently used content data in the internal memory in the SWAP device through the internal memory swap technology.

Swap-in: referring to a process in which the operating system installs content data that may be used back into the internal memory from the SWAP device through the internal memory swap technology.

The cloud technology (CT) refers to a hosting technology that unifies series of resources such as hardware, software, and network in a wide area network or a local area network, to implement computing, storage, processing, and sharing of data. The cloud technology is a generic term for a network technology, an information technology, an integration technology, a management platform technology, an application technology, and the like applied based on a cloud computing commercial mode, and may form a pool of resources, which is used on demand and is flexible and convenient. Back-end services of a technology network system require a huge amount of computing and storage resources, such as video websites, image websites, and more portal websites, and the cloud technology handles it efficiently. Accompanied with the high-level development and application of the Internet industry, every item may have its own identification mark in the future, which may be transmitted to a back-end system for logical processing. Data at different levels may be processed separately, and various types of industry data require strong system back support, which may be implemented through cloud computing.

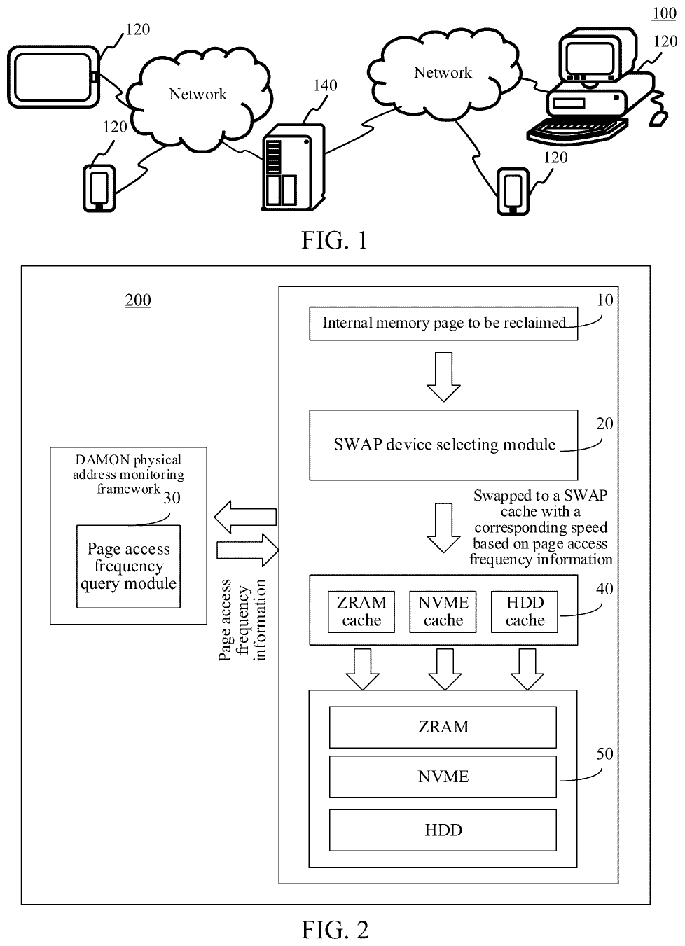

FIG. 1 is a block diagram of a structure of a system architecture according to some embodiments. The system architecture may be implemented as a system architecture of an internal memory reclaiming method. The system architecture 100 includes: a terminal 120 and a server 140.

The terminal 120 may be an electronic device such as a mobile phone, a tablet computer, a vehicle-mounted terminal, a wearable device, a personal computer (PC), an unmanned terminal, a household appliance, a virtual reality device, or an augmented reality device. For example, a client running a target application is installed in the terminal 120. The target application may be an application used for internal memory reclaiming, or another application provided with an internal memory reclaiming function. The form of the target application includes but is not limited to: an application (App), a mini program, or the like installed in the terminal 120, and may also be in the form of web pages. For example, an operating system of the terminal 120 is integrated with codes for realizing the internal memory reclaiming function.

The server 140 may be an independent physical server, or may be a server cluster or a distributed system including a plurality of physical servers, or may be a cloud server that provides cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The server 140 may be a backend server of the target application, and is configured to provide background services for clients of the target application.

In some embodiments, the server 140 may also be implemented as a node in a blockchain system. Blockchain is a new application mode of a computer technology such as distributed data storage, point-to-point transmission, consensus mechanism, and an encryption algorithm. The blockchain is essentially a decentralized database, and is a string of data blocks generated in a cryptographic manner. Each data block includes information about a batch of network transactions, which is used for verifying validity of the information (anti-counterfeiting) and generating a next block. The blockchain may include a blockchain underlying platform, a platform product service layer, and an application service layer.

The terminal 120 may communicate with the server 140 by using a network, for example, a wired or wireless network.

In the internal memory reclaiming method provided in some embodiments, operations may be performed by an operating system of a computer device in the system architecture 100, and the computer device is an electronic device having data computing, processing, and storage capabilities. Using some ebodiments shown in FIG. 1 as an example, the internal memory reclaiming method may be performed by the terminal 120 (for example, a client of a target application installed and run in the terminal 120 performs the internal memory reclaiming method), the internal memory reclaiming method may be performed by the server 140, or the internal memory reclaiming method may be performed by the terminal 120 and the server 140 in cooperation with each other. This is not limited herein.

A person skilled in the art may learn that there may be more or fewer terminals 120 in the system architecture 100. For example, a quantity of the terminals 120 may be only one, may be dozens or hundreds, or more.

FIG. 2 is a schematic diagram of an internal memory reclaiming method according to some embodiments, and an example in which the method is applied to a computer device 200 is used for description.

In some embodiments, the computer device 200 runs an operating system. In some embodiments, the operating system is also referred to as a computer system, for example these two words have similar meanings in some embodiments and may be interchangeable. For example, an operating system in the computer device 200 is a Linux system. For example, an operating system in the computer device 200 is a Windows system. In some embodiments, the method is performed by the operating system in the computer device 200.

In some embodiments, the SWAP device is used for storing content data that is swapped out from internal memory. In some embodiments, the computer device 200 includes at least two groups of SWAP devices. For any group of SWAP devices in the at least two groups of SWAP devices, the group of SWAP devices include at least one SWAP device. For example, each of the at least two groups of SWAP devices include one SWAP device, and in this case, the at least two groups of SWAP devices may be referred to as at least two levels of SWAP devices.

In some embodiments, SWAP devices in the same group are in a same level, but SWAP devices in different groups are in different levels.

In some embodiments, a level of a SWAP device is related to performance of the SWAP device. For example, better performance of a SWAP device indicates a higher level of the SWAP device. For example, a level of a SWAP device is positively correlated with bandwidth of the SWAP device; and higher bandwidth of a SWAP device indicates a higher level of the SWAP device.

In some embodiments, performance of a SWAP device is related to a type of the SWAP device. For example, the type of the SWAP device includes but is not limited to at least one of the following: physical hardware and a virtual storage block. The virtual storage block realizes, through software, a function of storing content data swapped out from physical internal memory. For example, the at least two groups of SWAP devices include: a high-level SWAP device group and a low-level SWAP device group. Performance of a high-level SWAP device is better than that of a low-level SWAP device.

In some embodiments, as shown in FIG. 2, the computer device 200 includes three groups of SWAP devices 50, and each group of SWAP devices include one SWAP device. The three groups of SWAP devices are: an internal memory optimization (ZRAM) device of a kernel, a non-volatile memory express (NVME) device, and a hard disk drive (HDD). Performance of the three groups of SWAP devices deteriorates in sequence. The kernel refers to a module of an operating system of a computer, and is used for managing system resources. In some embodiments, the ZRAM device belongs to a virtual storage block, while the NVME device and the HDD belong to physical hardware.

In some embodiments, the performance of the SWAP device includes an access speed. The access speed is used for measuring a response speed of the SWAP device to provide content data in response to a data access request. The data access request may be sent by internal memory of a computer device, a data loading module in a processor, and other components. The data access request includes identification information of the content data and a SWAP device used for storing content data. The data access request may be set, and is not limited herein.

The access speed of the SWAP device is set in some embodiments to determine, from at least two groups of SWAP devices, a target SWAP device of content data stored in an internal memory page. In some embodiments, there is a matching relationship between an access speed of a SWAP device and page access frequency information. For a SWAP device, an access speed of the SWAP device is used as a basis for determining whether content data stored in an internal memory page can be stored in the SWAP device.

For example, the access speed of the SWAP device is indicated by speed indication information. The speed indication information may be configured by a user. In some embodiments, a parameter included in the speed indication information correspond to a parameter included in the access frequency configuration information. For example, the user sets an access speed of the SWAP device based on bandwidth of the SWAP device. If bandwidth of a SWAP device is high, it is set that there is a matching relationship between an access speed of the SWAP device and active page access frequency information; and If bandwidth of a SWAP device is low, it is set that there is a matching relationship between an access speed of the SWAP device and inactive page access frequency information.

In some embodiments, the internal memory reclaiming method shown in FIG. 2 includes the following several operations.

Operation 1: Determine, in a case of receiving an internal memory reclaiming instruction, page access frequency information of an internal memory page to be reclaimed.

In some embodiments, the internal memory reclaiming instruction indicates to reclaim storage space that is occupied, in internal memory, by content data stored in an internal memory page. Internal memory reclaiming refers to emptying internal memory space (also referred to as storage space) occupied by the internal memory page in the internal memory, to increase a remaining available capacity in the internal memory. For example internal memory reclaiming is used for releasing internal memory space occupied by content data that is used not frequently in the internal memory. In other words, internal memory reclaiming is used for removing content data stored in internal memory from the internal memory. After internal memory reclaiming, storage space occupied by the content data in the internal memory may be used for storing new data content.

In some embodiments, the content data removed from the internal memory is stored in an external storage device (such as a SWAP device), so that the content data may be read from the external storage device when needed.

In some embodiments, the operating system 200 is provided with a frequency query module 30. The frequency query module 30 is also referred to as a page access frequency query module. The frequency query module 30 is used for querying access frequency information of an internal memory page. The operating system 200 determines, by using the frequency query module 30, page access frequency information of an internal memory page 10 to be reclaimed. For details of this operation, refer to the following embodiment.

In some embodiments, the frequency query module 30 is integrated in the operating system 200. For example, the frequency query module 30 is implemented by using code, and the frequency query module 30 is integrated on the operating system 200 by inserting code for implementing the frequency query module 30 into the operating system 200. For example, the frequency query module 30 is optimized based on a data access MONitor (DAMON) framework, and is implemented as an independent Linux kernel module. By integrating the frequency query module 30 into the operating system, the frequency query module 30 does not need to restart the operating system during a loading process, and it is easy to dynamically load the frequency query module 30.

Operation 2: Determine a target SWAP device matching the page access frequency information from the at least two groups of SWAP devices.

In some embodiments, the operating system 200 is provided with a SWAP device selecting module 20. The operating system 200 determines, by using the SWAP device selecting module 20, the target SWAP device matching the page access frequency information from the at least two groups of SWAP devices.

In some embodiments, the target SWAP device is used for receiving content data stored in the internal memory page. In some embodiments, the matching relationship between the page access frequency information and the SWAP devices is predefined. For example, the SWAP device selecting module 20 stores the matching relationship between the page access frequency information and the SWAP devices. The matching relationship indicates a SWAP device that the page access frequency information corresponds to. When a target SWAP device corresponding to an internal memory page may be determined, the SWAP device selecting module 20 determines, based on the matching relationship, a target SWAP device matching page access frequency information of the internal memory page.

In some embodiments, the matching relationship between the page access frequency information and the SWAP device conforms to a matching rule. For example, the matching rule is stored in the SWAP device selecting module 20. When a target SWAP device corresponding to an internal memory page may be determined, the SWAP device selecting module 20 determines whether the matching rule is met between page access frequency information of the internal memory page and speed access information of the target SWAP device. If the matching rule is met, the SWAP device is determined as the target SWAP device. For example, the matching rule is related to a quantitative relationship between the page access frequency information and the speed access information of the target SWAP device. For details, refer to the following embodiment.

Different internal memory pages have different pieces of page access frequency information, so different internal memory pages corresponding to different target SWAP devices. The method is helpful to allocate, based on page access frequencies of internal memory pages, content data stored in different internal memory pages to different SWAP devices for storage, and is helpful to make full use of SWAP devices with different performances.

Operation 3: Uninstall content data stored in the internal memory page to the target SWAP device, to reclaim the internal memory page.

In some embodiments, after determining the target SWAP device of the internal memory page, the operating system 200 immediately uninstalls content data stored in the internal memory page to the target SWAP device, and ends the internal memory reclaiming process.

It is considered that an access frequency of the operating system to the content data decreases with the increase of time. For example, in a process of calculation, the computer device may use content data frequently, and after the calculation is completed, a frequency of using the content data by the computer device gradually decreases, or the computer device even does not use the content data.

Before uninstalling the content data to the SWAP device, it may be considered to swap the content data out from the internal memory to a buffer storage area. Because access of a central processing unit to the content data may be discrete and irregular, after content data stored in an internal memory page is swapped out from internal memory, there may be a need to access the content data. A response speed of the SWAP device to a data access request is lower than a response speed to the data access request in the buffer storage area. To shorten time-consuming of obtaining the content data, the operating system 200 swaps the content data stored in the internal memory page from the internal memory to the buffer storage area. In a case that a total amount of content data cached in the buffer storage area exceeds a cache capacity of the buffer storage area, the operating system 200 stores data that is stored in the internal memory page in a target SWAP device of the internal memory page.

Compared with directly uninstalling the content data to the target SWAP device, this method is helpful to improve a speed of obtaining the content data swapped out from the internal memory by the operating system, and is helpful to improve operating efficiency of the operating system.

For example, the buffer storage area refers to cache 40.

In some embodiments, the at least two groups of SWAP devices have respective buffer storage areas in the operating system 200. In other words, different SWAP devices have different buffer storage areas. In some embodiments, the buffer storage areas of different SWAP devices are realized by software. For example, the operating system 200 divides first storage space in a cache address, and uses the storage space as a buffer storage area corresponding to a SWAP device.

For example, the operating system 200 includes three groups of SWAP devices, for example, ZRAM, NVME, and HDD. A buffer storage area corresponding to the ZRAM is ZRAM SWAP cache, a buffer storage area corresponding to the NVME is NVME SWAP cache, and a buffer storage area corresponding to the HDD is HDD SWAP cache.

For example, after determining a target SWAP device of an internal memory page, the operating system 200 stores content data that is stored in the internal memory page in a target buffer storage area of the target SWAP device; and in a case that a total amount of content data cached in the target buffer storage area exceeds a cache capacity of the target buffer storage area, the operating system 200 uninstalls the content data that is in the internal memory page to the target SWAP device.

In some embodiments, in a case that the content data exceeds the cache capacity of the target buffer storage area, the operating system 200 uninstalls content data that is in the internal memory page 10 to the target SWAP device, to reclaim the internal memory page.

In conclusion, the page access frequency information of the internal memory page is introduced, to select a SWAP device with appropriate performance. This is helpful to make full use of a high-performance SWAP device, and improves the utilization rate of the SWAP device. Through internal memory reclaiming, system internal memory is increased, and performance is also improved. Moreover, at least two groups of SWAP devices are set in the computer device (such as a server), to adaptively set any quantity, level, and type of internal memory partitions. Furthermore, a plurality of SWAP devices using different compression algorithms may be set, so that in a cloud scenario, a resource utilization rate may be improved, an oversold rate of the server may be improved, and costs of deploying the server may be reduced.

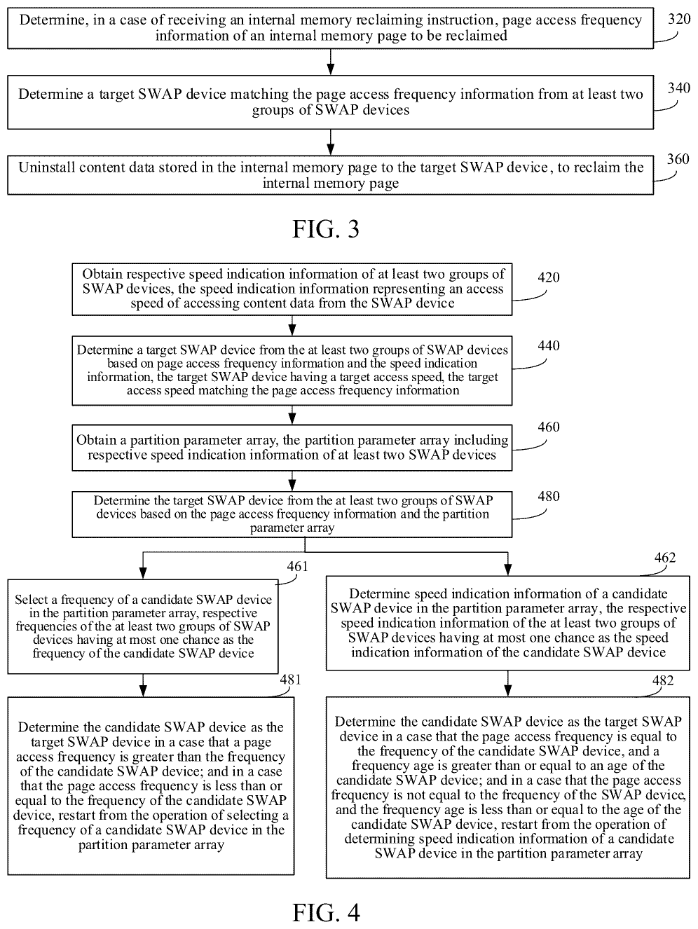

FIG. 3 is a flowchart of internal memory reclaiming according to some embodiments. Descriptions are provided by using an example in which the method is applied to a server 140 shown in FIG. 1, for example the server 140 is an execution body. In some embodiments, an operating system is installed in the server 140, and the server 140 includes at least two groups of SWAP devices. The method includes the following operations.

Operation 320: Determine, in a case of receiving an internal memory reclaiming instruction, page access frequency information of an internal memory page to be reclaimed.

The internal memory reclaiming instruction indicates to reclaim storage space that is occupied, in internal memory, by content data stored in an internal memory page. In some embodiments, an instruction condition for receiving the internal memory reclaiming instruction includes: a remaining capacity of the internal memory is less than or equal to a capacity threshold every first time interval. For example, a source of the capacity threshold includes at least one of the following: being preset and being related to operation of the operating system. For example, the capacity threshold is greater than or equal to internal memory space required by a program running in the operating system.

In some embodiments, the internal memory reclaiming instruction includes identification information of an internal memory page, and the identification information of the internal memory page indicates an internal memory page to which content data that may be swapped out in an internal memory reclaiming process belongs. After receiving the internal memory reclaiming instruction, the operating system of the server determines, based on the identification information of the internal memory page included in the internal memory reclaiming instruction, an internal memory page to be reclaimed, and then, the operating system of the server searches for page access frequency information of the internal memory page based on the identification information of the internal memory page.

The internal memory page is a unit for a kernel performing internal memory management. In some embodiments, the internal memory page includes an anonymous page for storing content data. The anonymous page refers to an internal memory page having no mapping relationship with disk files. The page access frequency information represents page access times and page access duration of the internal memory page. For example, the page access frequency information includes a page access frequency and an age of the page access frequency. The page access frequency represents a quantity of times for accessing the internal memory page in a unit time; and the age of the page access frequency refers to duration of maintaining the page access frequency by the internal memory page.

In some embodiments, the operating system is provided with a frequency query module, the frequency query module is used for providing page access frequency information of the internal memory page, and page access frequency information of the internal memory page to be reclaimed is determined by using the query module.

In an example, the operating system of the server generates an internal memory reclaiming instruction in a case that the internal memory page meets a reclaiming condition; the operating system determines, based on the internal memory reclaiming instruction, the internal memory page to be reclaimed; subsequently, the operating system of the server runs a hook function inserted in swap-out code of the internal memory page of the kernel, and the hook function is used for calling the frequency query module; and the page access frequency information of the internal memory page to be reclaimed is obtained through query of the frequency query module. For example, the operating system of the server sends identification information of an internal memory page to the frequency query module through the hook function; and the frequency query module queries page access frequency information of the internal memory page based on the identification information of the internal memory page. For details of this operation, refer to the following embodiment.

Operation 340: Determine a target SWAP device matching the page access frequency information from the at least two groups of SWAP devices.

In some embodiments, the target SWAP device is one of the at least two groups of SWAP devices. A target access speed corresponding to the target SWAP device matches the page access frequency. For example, that the target access speed matches the page access frequency indicates that the target access speed and the page access frequency meet a matching rule. The matching rule is related to a quantitative relationship between a parameter representing the target access speed (such as a parameter of the SWAP device below) and the page access frequency.

In some embodiments, that the computer device determines a target SWAP device matching the page access frequency information includes: obtaining respective speed indication information of the at least two groups of SWAP devices, and determining a target SWAP device matching the page access frequency information from the obtained respective speed indication information of the at least two groups of SWAP devices. For details, refer to the following embodiment.

In some embodiments, the operating system of the server is provided with a SWAP device selecting module, and the SWAP device selecting module is used for selecting a SWAP device matching the page access frequency information of the internal memory page.

In some embodiments, the SWAP device selecting module is integrated in the operating system. In some embodiments, the SWAP device selecting module is a module implemented as an independent Linux kernel module. For the content about this part, refer to the introduction of the frequency query module in the foregoing embodiment. The SWAP device selecting module is integrated in the operating system, so that the SWAP device selecting module is easy to be dynamically loaded. For example there is no need to restart the system when loading the SWAP device selecting module.

Operation 360: Uninstall content data stored in the internal memory page to the target SWAP device, to reclaim the internal memory page.

In some embodiments, the operating system determines whether the internal memory page meets a swap-out condition, to determine whether to uninstall the content data stored in the internal memory page to the target SWAP device or to uninstall the content data stored in the internal memory page to a buffer storage area of the target SWAP device. The buffer storage area of the target SWAP device is also referred to as a target buffer storage area. In a case that the internal memory page meets the swap-out condition, the server 140 uninstalls the content data stored in the internal memory page to the target SWAP device, to reclaim the internal memory page. In a case that the internal memory page does not meet the swap-out condition, the server 140 uninstalls the content data stored in the internal memory page to the target buffer storage area. The swap-out condition is a condition to be met to uninstall the content data stored in the internal memory page to the target SWAP device. In some embodiments, the swap-out condition includes but is not limited to at least one of the following: a data size of the content data stored in the internal memory page exceeds a cache capacity, and the content data that is stored in the internal memory page is stored in the target buffer storage area, resulting in a total amount of content data cached in the target buffer storage area exceeding. For example, the cache capacity includes a cache capacity of the buffer storage area of the target SWAP device.

For example, the cache capacity of the target buffer storage area is 32 KB, and if a data size of content data stored in an internal memory page is 33 KB, the internal memory page exceeds the cache capacity and meets the swap-out condition. For another example, the cache capacity of the target buffer storage area is 64 KB. If a data size of content data stored in an internal memory page is 3 KB, and data increment of the target buffer storage area is 62 KB, the internal memory page meets the swap-out condition, and the content data stored in the internal memory page may be uninstalled to the target SWAP device.

Uninstall refers to an operation of deleting program files and folders from the hard disk and deleting related data from the registry. In some embodiments, uninstall refers to deleting content data stored in an internal memory page from internal memory and writing the content data of the internal memory page into a target SWAP device or a buffer storage area of the target SWAP device. The operating system of the server 140 uninstalls the content data stored in the internal memory page, to release storage space occupied by the internal memory page in the internal memory.

In some embodiments, the server 140 compresses, by using a compression algorithm, the content data stored in the internal memory page, to obtain compressed content data, and the server 140 uninstalls the compressed content data to the target SWAP device, to reclaim the internal memory page.

In some embodiments, different target SWAP devices may also use different compression algorithms, and the different compression algorithms have a difference in at least one of a compression rate and/or a compression speed. The compression algorithm may be any algorithm that can compress the content data in the internal memory page, and a type of the compression algorithm is not limited herein.

In conclusion, according to the internal memory reclaiming method provided in some embodiments, in a case that the content data stored in the internal memory page of the internal memory may be swapped out from the internal memory, the SWAP device matching the access frequency of the content data stored in the internal memory page is determined based on the page access frequency information of the internal memory page, to store the content data that is stored in the internal memory page in the SWAP device. Compared with the related art, the operating system directly and preferentially stores, based on priorities of the at least two groups of SWAP devices, the content data that is stored in the internal memory page in a SWAP device with a higher priority; and in some embodiments, the page access frequency information of the internal memory page is introduced, and a SWAP device with appropriate performance is selected for content data with different access frequencies based on the page access frequency information of the internal memory page.

On the one hand, it is helpful to avoid storing content data with a low access frequency in a SWAP device with high data transmission performance, resulting in performance waste of the SWAP device; and on the other hand, it is helpful to avoid storing content data with a high access frequency in a SWAP device with low data transmission performance, and shorten time-consuming for the operating system to obtain swapped-out content data from the SWAP device. It is helpful to make full use of a high-performance SWAP device, improve a utilization rate of the SWAP device, increase system internal memory through internal memory reclaiming, and improve performance of the operating system.

In some embodiments, the computer device includes at least two groups of SWAP devices. Because performance of the at least two groups of SWAP devices is different, for example access speeds are different, when a corresponding target SWAP device is determined based on the page access frequency information of the internal memory page to be reclaimed, speed indication information indicating an access speed of each SWAP device may be obtained first, to determine the target SWAP device.

FIG. 4 is a flowchart of an internal memory reclaiming method according to some embodiments. The method is performed by a computer device (such as a server or a terminal), for example, an operating system in the computer device. In some embodiments, operation 340 includes the following operation 420 and operation 440.

Operation 420: Obtain respective speed indication information of the at least two groups of SWAP devices, the speed indication information representing an access speed of accessing content data from the SWAP device.

The speed indication information is information indicating an access speed of the SWAP device.

In some embodiments, the access speed of the SWAP device is set by a user. In some embodiments, the computer device generates speed indication information of a first SWAP device in response to an operation of setting a specified access speed of the first SWAP device in the operating system. The first SWAP device refers to a SWAP device turned on in the operating system, for example the first SWAP device may participate in an internal memory reclaiming process, and the first SWAP device is referred to as a preset SWAP device.

In some embodiments, each preset SWAP device in the operating system is provided with an enable switch, and an enabled state of the enable switch indicates whether an operation of setting an access speed is allowed to be enabled for a corresponding preset SWAP device.

For example, in a case that the enable switch of the first SWAP device is in the ON state, the computer device generates speed indication information of the preset SWAP device in response to the operation of setting the specified access speed of the first SWAP device.

For example, the computer device separately obtains speed indication information indicating access speeds of at least two groups of SWAP devices. In some embodiments, the access speed of the SWAP device is represented by using at least one of the following: a frequency of the SWAP device and an age of the SWAP device. In some embodiments, the frequency of the SWAP device represents a page access frequency of an internal memory page to which content data stored in the SWAP device belongs, and the age of the SWAP device represents duration of maintaining a page access frequency by the internal memory page to which the content data stored in the SWAP device belongs.

In some embodiments, the frequency of the SWAP device and the age of the SWAP device may be configured by a user, and the user refers to a user of the operating system.

Operation 440: Determine the target SWAP device from the at least two groups of SWAP devices based on the page access frequency information and the speed indication information, the target SWAP device having a target access speed, the target access speed matching the page access frequency information.

In some embodiments, the target access speed is an access speed matching the page access frequency information. For example, there is a matching relationship between the target access speed and the page access frequency information. The target SWAP device refers to a SWAP device with a target access speed.

In some embodiments, the frequency of the SWAP device refers to a frequency interval, and the age of the SWAP device refers to a duration interval; if a page access frequency of an internal memory page is in a frequency internal of a SWAP device, content data stored in the internal memory page may be stored in the SWAP device; and if a page access frequency of an internal memory page is not in a frequency internal of a SWAP device, content data stored in the internal memory page may not be stored in the SWAP device, for example the SWAP device cannot be used as a target SWAP device of the internal memory page.

In some embodiments, the frequency of the SWAP device refers to a fixed frequency value, and the age of the SWAP device refers to a fixed duration value. If a difference between a page access frequency of an internal memory page and a frequency of a SWAP device is less than or equal to a first threshold, content data stored in the internal memory page may be stored in the SWAP device; and if a difference between a page access frequency of an internal memory page and a frequency of a SWAP device is greater than the first threshold, content data stored in the internal memory page may not be stored in the SWAP device. The first threshold may be set by the user.

For example, the computer device compares a frequency of each SWAP device with a page access frequency of an internal memory page in descending order of the frequency of the SWAP device, and if a frequency of a SWAP device is higher than the frequency of the SWAP device of the internal memory page for the first time, the SWAP device is used as the target SWAP device. For details of this process, refer to the following embodiment.

In some embodiments, the target SWAP device may be determined from the at least two groups of SWAP devices based on the speed indication information of the SWAP device, the page access frequency information of the internal memory page, and the respective speed indication information of the at least two groups of SWAP devices. Compared with the related art in which the content data that is stored in the internal memory pages is preferentially stored in a SWAP device with a higher priority, the foregoing embodiment is helpful to improve adaptability between the access speed of the target SWAP device and the access frequency of the internal memory page, avoid uninstalling content data with a low access frequency to a SWAP device with a high access speed, or uninstalling content data with a high access frequency to a SWAP device with a low access speed. In this way, the internal memory page may be swapped out to a SWAP device with a corresponding speed, which is helpful to improve the utilization rate of the SWAP device.

In some embodiments, that the computer device determines the target SWAP device from the at least two groups of SWAP devices based on the page access frequency information and the speed indication information includes: The computer device obtains a partition parameter array, the partition parameter array including respective speed indication information of at least two SWAP devices; and the computer device determines the target SWAP device from the at least two groups of SWAP devices based on the page access frequency information and the partition parameter array.

In some embodiments, for a SWAP device (for example the first SWAP device or the preset SWAP device in the previous embodiment) that enables the operation of setting the specified access speed, the computer device stores speed indication information of the SWAP device in the partition parameter array.

In some embodiments, the computer device stores the respective speed indication information of the at least two groups of SWAP devices in the partition parameter array. In some embodiments, different elements of the partition parameter array are used for storing speed indication information of different SWAP devices. For example, it is assumed that each group of SWAP devices include one SWAP device, speed indication information of an i^{th} level of SWAP device is stored in element A[1] of partition parameter array A, and speed indication information of an i+1^{th} level of SWAP device is stored in element A[2] of partition parameter array A, where i is a natural number.

In some embodiments, the respective speed indication information of the at least two groups of SWAP devices is randomly arranged in the partition parameter array. In some embodiments, the respective speed indication information of the at least two groups of SWAP devices has an arrangement order in a storage location of the partition parameter array.

In some embodiments, the speed indication information includes the frequency of the SWAP device and the age of the SWAP device, and an order of the speed indication information of the SWAP device in the partition parameter array is negatively correlated with the frequency of the SWAP device; and in a case that frequencies of a plurality of SWAP devices are the same, an order of speed indication information of the plurality of SWAP devices in the partition parameter array is positively correlated with the age of the SWAP device.

For example, the speed indication information includes the frequency of the SWAP device and the age of the SWAP device. A lower frequency of the SWAP device indicates a higher location of the speed indication information of the SWAP device in the partition parameter array, and a higher frequency of the SWAP device indicates a lower location of the speed indication information of the SWAP device in the partition parameter array. In a case that frequencies of the SWAP devices are the same, a longer age of a SWAP device indicates a higher location of the speed indication information of the SWAP device in the partition parameter array.

In some embodiments, in a process of determining the target SWAP device, a target SWAP device matching the page access frequency is determined by traversing speed indication information of all SWAP devices. In some embodiments, operation 440 may include the following operations.

Operation 460: Obtain a partition parameter array, the partition parameter array including respective speed indication information of at least two SWAP devices.

Operation 480: Determine the target SWAP device from the at least two groups of SWAP devices based on the page access frequency information and the partition parameter array.

In some embodiments, the computer device traverses from front to back, in an order in which the respective speed indication information of the at least two groups of SWAP devices is stored in the partition parameter array, the partition parameter array corresponding to the at least two groups of SWAP devices.

In a process of traversing the partition parameter array, for speed indication information of each SWAP device, the computer device determines whether the speed indication information of the SWAP device matches the page access frequency information of the internal memory page. If the speed indication information of the SWAP device matches the page access frequency information of the internal memory page, the computer device determines the SWAP device as the target SWAP device and stops traversing the partition parameter array; and if the speed indication information of the SWAP device does not match the page access frequency information of the internal memory page, the computer device continues to traverse the partition parameter array until the traversal of the partition parameter array is completed. In some embodiments, based on the page access frequency information and the speed indication information in the partition parameter array, the target SWAP device with a target access speed matching the page access frequency information is determined among the at least two groups of SWAP devices, and this traversal manner can improve accuracy of the determined target SWAP device.

In some embodiments, the speed indication information of the SWAP device includes the frequency of the SWAP device; and the page access frequency information includes a page access frequency. The computer device determines the target SWAP device by comparing the page access frequency of the internal memory page with the frequency of the SWAP device. Based on this, operation 460 may be implemented as operation 461, and operation 480 may be implemented as operation 481.

Operation 461: Select a frequency of a candidate SWAP device in the partition parameter array, respective frequencies of the at least two groups of SWAP devices having at most one chance as the frequency of the candidate SWAP device.

In some embodiments, the computer device selects the frequency of the candidate SWAP device from the partition parameter array in descending order. For example, starting from the first element in the partition parameter array, the computer device determines a frequency of the SWAP device stored in the first element as the frequency of the candidate SWAP device.

According to some embodiment, the speed indication information of the at least two groups of SWAP devices may be stored in the partition parameter array in a order. For example, a low frequency of a SWAP device is preferentially stored in a high location of the partition parameter array. For example the computer device preferentially determines, from the partition parameter array, the low frequency of the SWAP device as the frequency of the candidate SWAP device. Certainly, the computer device may also preferentially determine, from the partition parameter array, a high frequency of the SWAP device as the frequency of the candidate SWAP device, and an order of selecting the frequency of the candidate SWAP device from the partition parameter array is not limited herein.

Operation 481: Determine the candidate SWAP device as the target SWAP device in a case that the page access frequency is greater than the frequency of the candidate SWAP device; and in a case that the page access frequency is less than or equal to the frequency of the candidate SWAP device, restart from the operation of selecting a frequency of a candidate SWAP device in the partition parameter array.

According to some embodiments, the target SWAP device is determined based on the frequency of the SWAP device and the page access frequency of the internal memory page, so that the access speed of the target SWAP device supports efficient access to the content data stored in the internal memory page, and it avoids allocating a SWAP device with a high frequency to the internal memory page. This is helpful to realize proper utilization of performance of the SWAP device.

In some embodiments, the speed indication information of the SWAP device includes: the frequency of the SWAP device and an age of the SWAP device, and the page access frequency information of the internal memory page includes: a page access frequency and a frequency age. The computer device determines the target SWAP device by comparing the page access frequency of the internal memory page with the frequency of the SWAP device, and the page access frequency age of the internal memory page with the age of the SWAP device.

Based on this, operation 460 may be implemented as operation 462, and operation 480 may be implemented as operation 482.

Operation 462: Determine speed indication information of a candidate SWAP device in the partition parameter array, the respective speed indication information of the at least two groups of SWAP devices having at most one chance as the speed indication information of the candidate SWAP device.

Operation 482: Determine the candidate SWAP device as the target SWAP device in a case that the page access frequency is equal to the frequency of the candidate SWAP device, and the frequency age is greater than or equal to an age of the candidate SWAP device; and in a case that the page access frequency is not equal to the frequency of the SWAP device, and the frequency age is less than or equal to the age of the candidate SWAP device, restart from the operation of determining speed indication information of a candidate SWAP device in the partition parameter array.

In an example, the computer device selects the speed indication information of the candidate SWAP device from the partition parameter array in descending order of the frequency of the SWAP device. Subsequently, the computer device compares a quantitative relationship between the page access frequency and the frequency of the candidate SWAP device, and a quantitative relationship between the frequency age and the age of the candidate SWAP. The computer device determines the candidate SWAP device as the target SWAP device if the page access frequency is not equal to the frequency of the SWAP device, and the frequency age is less than or equal to the age of the candidate SWAP device. Otherwise, the computer device selects speed indication information of another SWAP device from the partition parameter array as the speed indication information of the candidate SWAP device until the speed indication information of the candidate SWAP device cannot be selected from the partition parameter array. Speed indication information of each SWAP device is selected as the speed indication information of the candidate SWAP device once or less. In some embodiments, the speed indication information of each SWAP device in the at least two groups of SWAP devices is traversed, and the target SWAP device is determined based on the speed access information and the page access frequency information of the candidate SWAP device. It is helpful to find a target SWAP device that adapts to the internal memory page and improve accuracy of determining the target SWAP device.

In some embodiments, if the target SWAP device cannot be determined, the target SWAP device may be determined according to a kernel native SWAP priority policy.

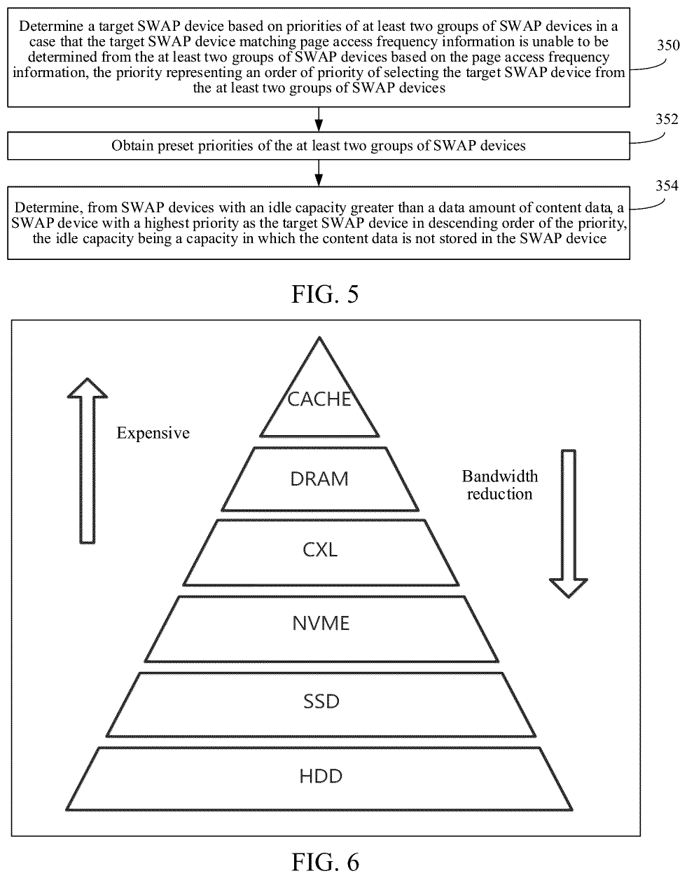

For example, FIG. 5 is a flowchart of an internal memory reclaiming method according to some embodiments. The method is performed by a computer device (such as a server or a terminal), for example, an operating system in the computer device. The method may further include the following operations.

Operation 350: Determine the target SWAP device based on priorities of the at least two groups of SWAP devices in a case that the target SWAP device matching the page access frequency information is unable to be determined from the at least two groups of SWAP devices based on the page access frequency information, the priority representing an order of priority of selecting the target SWAP device from the at least two groups of SWAP devices.

The priority refers to a preset priority of each SWAP device in the at least two groups of SWAP devices. The priority represents an order in which the SWAP device is used as the target SWAP device.

In some embodiments, the target SWAP device is determined based on priorities of the at least two groups of SWAP devices in a case that the target SWAP device matching the page access frequency information is unable to be determined from the at least two groups of SWAP devices based on the page access frequency information. In some embodiments, the priorities of the at least two groups of SWAP devices are set by the user.

Still refering to FIG. 5, operation 350 may be implemented as operation 352 and operation 354.

Operation 352: Obtain the priorities of the at least two groups of SWAP devices. In some embodiments, the computer device determines a priority of each SWAP device in the at least two groups of SWAP devices in response to the operation of setting the priority of the SWAP device.

For example, preset priorities of the at least two groups of SWAP devices are obtained. In some embodiments, the priority of the SWAP device is set with reference to a price and bandwidth of the SWAP device. If the bandwidth is larger, the priority is higher.

FIG. 6 is a schematic diagram of a SWAP device according to some embodiments. Refer to FIG. 6, that the SWAP device includes cache, dynamic random access memory (DRAM), compute express link (CXL), NVME, SSD, and HDD is used as an example. Prices and bandwidth of the SWAP devices decrease in turn, and the user may set the priority of the SWAP device based on the price and the bandwidth of the SWAP device.

Operation 354: Determine, from SWAP devices with an idle capacity greater than a data amount of the content data, a SWAP device with a highest priority as the target SWAP device in descending order of the priority, the idle capacity being a capacity in which the content data is not stored in the SWAP device.

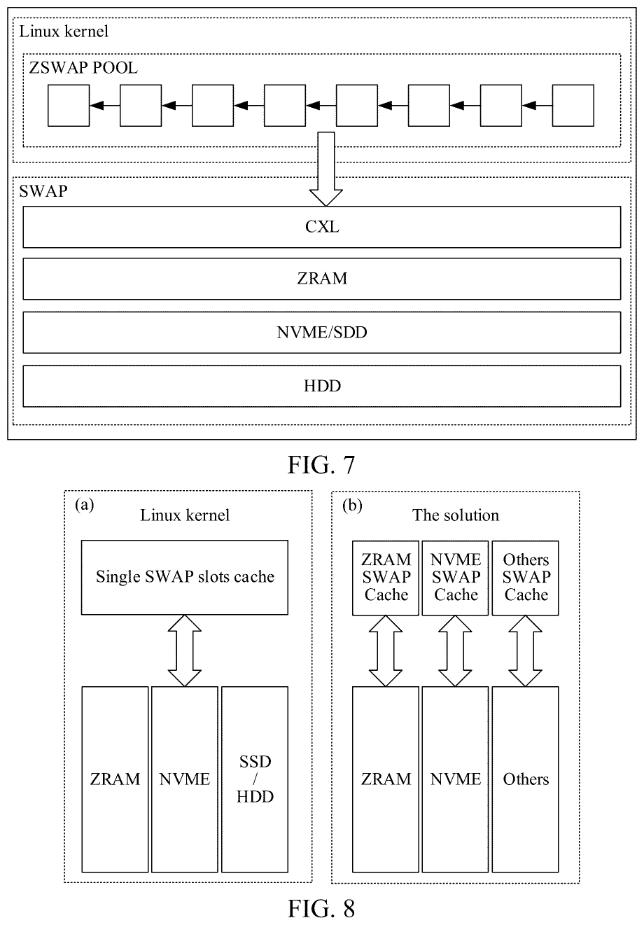

For example, FIG. 7 is a schematic diagram of an internal memory reclaiming method according to some embodiments. Refer to FIG. 7, there are a plurality of SWAP devices in the computer device in a priority order of CXL, ZRAM, NVME/SDD and HDD in turn. When the internal memory page is swapped out, the content data of the internal memory page is first swapped out to the SWAP device with the highest priority, for example, CXL, then is swapped out to the SWAP device with the second highest priority, for example, ZRAM, when the SWAP device with the highest priority is used up, and so on.

In some embodiments, the target SWAP device is determined according to a kernel native SWAP priority policy in a case that the target SWAP device matching the page access frequency information is unable to be determined from the at least two groups of SWAP devices based on the page access frequency information, which may ensure that the internal memory page can be reclaimed and improve system internal memory. Moreover, this priority-based manner may be due to a compromise between device costs and access performance, which can realize that frequently accessed pages are stored on faster but expensive devices, and infrequently accessed pages are stored on slow and cheap devices, to make full use of the SWAP device and improve the utilization rate of the SWAP device to some extent.

In some embodiments, FIG. 8 is a schematic diagram of a buffer storage area according to some embodiments. Refer to (a) in FIG. 8. A native SWAP slots cache module of the computer device is a single SWAP slots cache, and a usage rule of the SWAP device is also sorting based on a defined priority. A page to be swapped out is preferentially swapped out to the SWAP device with the highest priority, and when the SWAP device with the highest priority is used up, it is swapped out to the SWAP device with the second highest priority, and so on.

However, slots of the SWAP device are cached in batches (generally 32 slots) in turn in the single SWAP slots cache, and this single SWAP slots cache is not feasible for an uninstalling purpose of a plurality of levels of SWAP devices in the embodiments of this application. For example, if a native single SWAP slots cache is caching slots of an NVME device, and now a cold page may be delivered to an HDD device, the single SWAP slots cache is invalid in this case, which easily causes performance bumps.

Based on this, on the basis that the computer device in some embodiments is provided with at least two groups of SWAP devices, the at least two groups of SWAP devices have respective buffer storage areas in the computer device. Refer to (b) in FIG. 8. For example, if the SWAP device in the computer device includes ZRAM, MVME, and other devices, a ZRAM SWAP cache, an NVME SWAP cache, and other SWAP caches are set correspondingly.

In some embodiments, after determining the target SWAP device corresponding to the internal memory page, the computer device caches the content data that is stored in the internal memory page in a corresponding buffer storage area of the target SWAP device, and then uninstalls the content data to the target SWAP device.

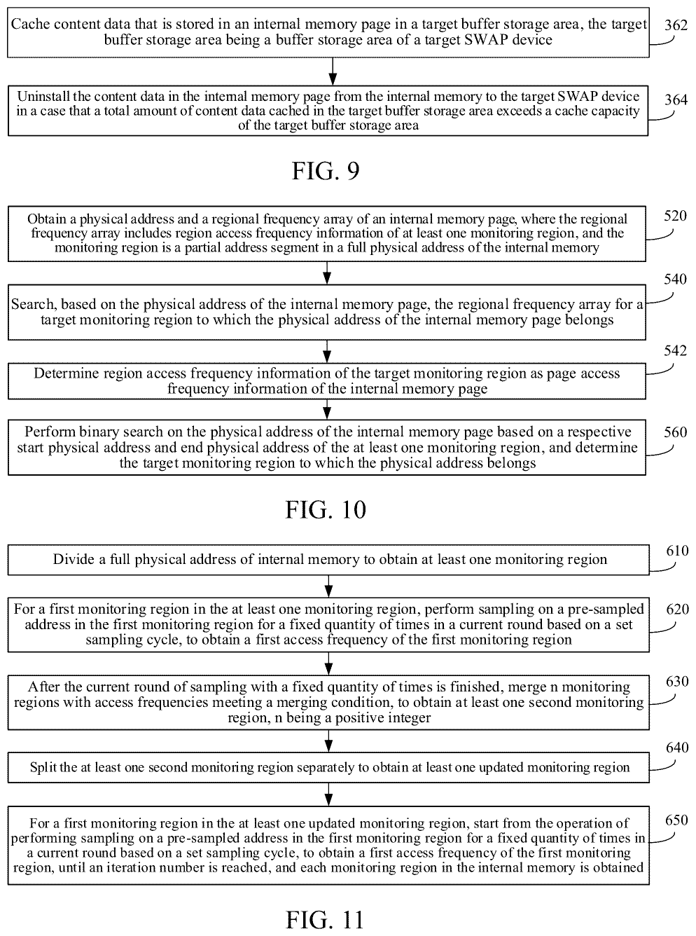

In some embodiments, FIG. 9 is a flowchart of an internal memory reclaiming method according to some embodiments. Some embodiments is implemented by a computer device. Operation 360 may be implemented as the following operations.

Operation 362: Cache the content data that is stored in the internal memory page in a target buffer storage area, the target buffer storage area being a buffer storage area of the target SWAP device. The target buffer storage area refers to cache corresponding to the target SWAP device. Each SWAP device has a corresponding buffer storage area. In some embodiments, the target buffer storage area corresponding to the target SWAP device is determined.

Operation 364: Uninstall the content data in the internal memory page from the internal memory to the target SWAP device in a case that a total amount of content data cached in the target buffer storage area exceeds a cache capacity of the target buffer storage area.

The cache capacity refers to the maximum capacity of content data that can be stored in the target buffer storage area.

For example, in a case that the content data exceeds the cache capacity of the target buffer storage area, the computer device uninstalls the content data in the internal memory page to the target SWAP device, to reclaim the internal memory page.

In some embodiments, in a case that the content data exceeds a cache capacity of the target buffer storage area, the computer device further uninstalls all of the content data in the target buffer storage area to the target SWAP device. In some embodiment, the single SWAP slots cache is optimized, and a buffer storage area is configured for each SWAP device. According to this, an internal memory page that may be swapped out may be preferentially cached in a corresponding target buffer storage area, and then washed to the SWAP device at one time in a batch, thereby ensuring performance of concurrent swap-in and swap-out of a plurality of SWAP devices.

Some embodiments are based on determining the page access frequency information of the internal memory page to be reclaimed, so the page access frequency information of the internal memory page may be obtained first.

For example, FIG. 10 is a flowchart of an internal memory reclaiming method according to some embodiments. Some embodiments is implemented by a computer device. Based on some embodiments, operation 320 may include the following operations.

Operation 520: Obtain a physical address and a regional frequency array of the internal memory page, where the regional frequency array includes region access frequency information of at least one monitoring region, and the monitoring region is a partial address segment in a full physical address of the internal memory.

The physical address of the internal memory page indicates addressing space of the internal memory page in the internal memory.

In some embodiments, the physical address of the internal memory page=block number*block length+intra-page address. The block length is equal to a page size. In some embodiments, the physical address of the internal memory page may be obtained through calculation based on a logical address of the internal memory page. In some embodiments, the computer device searches for the physical address of the internal memory page by using the identification information of the internal memory page. The identification information of the internal memory page is used for uniquely identifying the internal memory page.

In some embodiments, the full physical address of the internal memory represents a set of storage addresses that all physical internal memory in the computer device have. For example, for any physical address in the full physical address, the physical address may be used for accessing data stored in a location of the internal memory space.

In some embodiments, the monitoring region includes a part of the full physical address. In some embodiments, the computer device obtains a plurality of monitoring regions by dividing the full physical address. Sizes of the plurality of monitoring regions may be the same, and the plurality of monitoring regions do not include the same physical address. For example, a full physical address is [0,2048], an address segment of monitoring region 1 is [0,511], and an address segment of monitoring region 2 is [512,1023]. The full physical address is divided, so that access frequency information of each internal memory page in the full physical address may be grasped based on a monitoring region.

In some embodiments, the region access frequency information is configured for recording an access frequency of each monitoring region.

Operation 540: Search, based on the physical address of the internal memory page, the regional frequency array for a target monitoring region to which the physical address of the internal memory page belongs.

The monitoring region refers to a plurality of regions divided when the full physical address of the internal memory is monitored. For example, the full physical address of the internal memory is monitored based on a DAMON framework, and each monitoring region is dynamically divided. The DAMON monitoring framework monitors cold and hot distribution of global internal memory with very low overheads, for example determines access frequency information of each monitoring region. The access frequency information of the monitoring region may be stored in the regional frequency array. For example, a maximum quantity of monitoring regions is set by the user. In this method, overheads of DAMON monitoring are guaranteed to have an upper bound, which is helpful to avoid dividing the full physical address into finely divided monitoring regions and to reduce consumed calculation resources and storage resources in maintaining the regional frequency array, and reduces calculation overheads.

In some embodiments, address information corresponding to each monitoring region of the computer device is stored in the regional frequency array, to match the physical address of the internal memory page. For example, the computer device searches regional frequency arrays corresponding to all monitoring regions for the physical address, and determines the regional frequency array matching the physical address.

Operation 560: Determine region access frequency information of the target monitoring region as the page access frequency information of the internal memory page.

In some embodiments, after determining the target monitoring region matching the physical address, the computer device determines the access frequency information of the target monitoring region as the page access frequency information of the internal memory page.

In some embodiments, additional page access frequency information may be provided for the internal memory page that may be swapped out, which may swap out internal memory pages with different page access frequencies to SWAP devices with corresponding speeds.

In some embodiments, the regional frequency array stores access frequency information, and further stores address information corresponding to each monitoring region of the computer device. For example, the regional frequency array further includes a start physical address and an end physical address corresponding to the monitoring region.

The physical address of the internal memory page may be searched for based on the start physical address and the end physical address, to determine the regional frequency array matching the internal memory page. Still refer to FIG. 10, operation 540 may be implemented as operation 542.

Operation 542: Perform binary search on the physical address of the internal memory page based on a respective start physical address and end physical address of the at least one monitoring region, and determine the target monitoring region to which the physical address belongs.

Bisection method is a method in which a physical address interval is divided into two, and a physical address interval in which the physical address of the internal memory page is located is gradually determined. In some embodiments, based on the start physical address and the end physical address included in the regional frequency array corresponding to each monitoring region of the computer device, binary search is performed on the physical address to determine the physical address interval in which the physical address is located. In some embodiments, the computer device determines the regional frequency array corresponding to the physical address interval in which the physical address of the internal memory page is located as the regional frequency array matching the physical address. Therefore, the access frequency information included in the regional frequency array is determined as the page access frequency information of the internal memory page.

In some embodiments, the page access frequency information corresponding to the internal memory page may be determined by establishing a regional frequency array and searching for, by using the bisection method based on the physical address of the internal memory page, the regional frequency array matching the internal memory page. During implementation of a native DAMON monitoring framework, because monitoring regions need to be split and merged dynamically, the monitoring regions are linked in series by using a linked list. Based on this, if a linked list is searched for a corresponding monitoring region based on the physical address of the internal memory page, time complexity is O(n). In some embodiments, the time complexity can be effectively reduced by establishing and searching regional frequency data.

In some embodiments, an entire physical address of the computer device is monitored based on a DAMON monitoring framework, and each monitoring region of the computer device is dynamically divided.

There are many system RAMs in a general computer device. In the related art, a DAMON physical address monitoring method is to scan a system RAM linked list registered in the computer device, and select the largest RAM device for monitoring. However, in this monitoring method, it is easy to lose many physical address ranges that need to be monitored.

In some embodiments, a single system RAM monitoring policy is extended to full physical address monitoring. Based on this, FIG. 11 is a schematic diagram of an internal memory reclaiming method according to some embodiments. Based on the embodiment shown in FIG. 10, the method further includes the following operations.

Operation 610: Divide the full physical address of a computer device to obtain at least one monitoring region.

In some embodiments, the full physical address refers to all physical addresses included in internal memory of the computer device.

The monitoring region is a continuous address segment obtained by dividing the full physical address. In some embodiments, a maximum quantity of monitoring regions obtained by dividing the full physical address is set by a user based on overheads.

In some embodiments, the full physical address of the computer device is divided to obtain at least one monitoring region. Address segment sizes of monitoring regions may be the same or different, which is not limited in some embodiments. In some embodiments, address segments of different monitoring regions do not overlap.

Operation 620: For a first monitoring region in the at least one monitoring region, perform sampling on a pre-sampled address in the first monitoring region for a fixed quantity of times in a current round based on a set sampling cycle, to obtain a first access frequency of the first monitoring region.

In some embodiments, the pre-sampled address refers to a physical address randomly selected in the monitoring region. A pre-sampled address in each monitoring region is different from each other. The set sampling cycle indicates a time interval of an access frequency for collecting the pre-sampled address. The set sampling cycle may be set by the user, for example, the set sampling cycle is to perform sampling on a pre-sampled address every 16 clock cycles. In some embodiments, after the fixed quantity of times of sampling in this round is finished, an access flag bit of the pre-sampled address of the monitoring region is checked and counted, and an access frequency corresponding to each monitoring region may be determined. The fixed quantity of times is a preset quantity of times.

The first access frequency refers to an access frequency corresponding to the first monitoring region. Page access frequencies of all internal memory pages included in the first monitoring region are determined based on the first access frequency.

In some embodiments, the computer device performs sampling on the pre-sampled address in the monitoring region for the fixed quantity of times in the current round based on the set sampling cycle, to obtain the access frequency of the monitoring region.

Operation 630: After the current round of sampling with a fixed quantity of times is finished, merge n monitoring regions with access frequencies meeting a merging condition, to obtain at least one second monitoring region, n being a positive integer.

Merging refers to merging two different monitoring regions. For example address segments of two monitoring regions are merged. For example, an address segment of monitoring region 1 is [127,255], and an address segment of monitoring region 2 is [256,384]. Monitoring region 1 and monitoring region 2 are merged, and an address segment of the second monitoring region is [127,384].

The merging condition refers to a condition that may be met to merge two monitoring regions. In some embodiments, the merging condition includes that access frequencies of two monitoring regions with adjacent addresses are the same, for example the access frequencies of the two monitoring regions with adjacent addresses are equal.

In some embodiments, the merging condition includes that a difference between access frequencies of two monitoring regions with adjacent addresses is less than a threshold, for example first access frequencies of the two monitoring regions with adjacent addresses are similar.

The second monitoring region refers to a monitoring region obtained by merging monitoring regions.

In some embodiments, based on the first access frequency of the monitoring region, the computer device merges monitoring regions meeting the merging condition, to obtain the second monitoring region. A quantity of the second monitoring regions is less than that of the first monitoring regions.

Operation 640: Split the at least one second monitoring region separately to obtain at least one updated monitoring region.

Split refers to dividing a monitoring region into a plurality of monitoring regions. For example an address segment of a monitoring region is split to obtain a plurality of non-overlapping address segments, and the plurality of address segments are corresponding address segments of a plurality of monitoring regions obtained by dividing the monitoring region.

For example, each second monitoring region is split to obtain at least one updated monitoring region.

In some embodiments, splitting the second monitoring region is to divide the second monitoring region into equal parts, such as bisecting, trisecting, or quartering the second monitoring region. In some embodiments, splitting the second monitoring region is not to divide the second monitoring region into equal parts.

At this point, one iteration in an iteration cycle is completed. The computer device clears an access frequency of the at least one updated monitoring region for next iteration in the iteration cycle.

Operation 650: For a first monitoring region in the at least one updated monitoring region, start from the operation of performing sampling on a pre-sampled address in the first monitoring region for a fixed quantity of times in a current round based on a set sampling cycle, to obtain a first access frequency of the first monitoring region, until an iteration number is reached, and region access frequency information of each monitoring region is obtained.

The iteration number is a preset number.

In some embodiments, based on the set sampling cycle, sampling is performed on a pre-sampled address in a third monitoring region for a fixed quantity of times in a next round until the iteration number is reached, and each monitoring region of the computer device is obtained.

For example, after reaching the iteration number, an access frequency of each monitoring region of the computer device converges. Then, access frequency information of each monitoring region may be stored in the regional frequency array.

In some embodiments, full physical address monitoring is performed based on a DAMON monitoring framework, to provide page access frequency information of the internal memory page. Moreover, the DAMON monitoring framework is lightweight, monitoring overheads are relatively small, and detailed page access frequency information may be provided. In addition, the DAMON monitoring framework is implemented in the kernel, so that corresponding page access frequency information may be obtained when the internal memory page is swapped out.

In some embodiments, because access frequency information of each monitoring region stored in the regional frequency array may be modified in the iteration cycle, and when the SWAP device is swapped out, the regional frequency array may be searched for to obtain the page access frequency information of the internal memory page. This leads to concurrent access, and read access is more frequent than write access.

Based on this, a read-write lock or read-copy update (RCU) is used for protecting the regional frequency array, to ensure a concurrency rate of data reading and writing. When the page access frequency information of the internal memory page is obtained based on a page access frequency query module, a concurrency rate of the page access frequency query module is also guaranteed.

In some embodiments, in a process that an entire physical address of the computer device is monitored based on the DAMON monitoring framework, a water mark mechanism of the native DAMON monitoring framework is removed.

Query of the page access frequency of the internal memory page may occur at any time of the computer device and in any remaining free internal memory, which violates the water mark mechanism, and the water mark mechanism is removed.

In some embodiments, in a process that a full physical address of the computer device is monitored based on the DAMON monitoring framework, a schemes mechanism of the native DAMON monitoring framework is removed.

The schemes mechanism is used for the user to specify some rules and actions, and implement corresponding actions on a monitoring region that meets the rules, such as: reclaiming a monitoring region with a low access frequency. In some embodiments, the page access frequency query module is only used for providing access frequency information of the internal memory page, and the schemes mechanism is not needed.

In some embodiments, in the process of monitoring the entire physical address of the computer device based on the DAMON monitoring framework, a quantity of sampling cycles and a maximum quantity of monitoring regions in the native DAMON monitoring framework are increased. Based on this, accuracy of the page access frequency information determined in some embodiments may be improved.

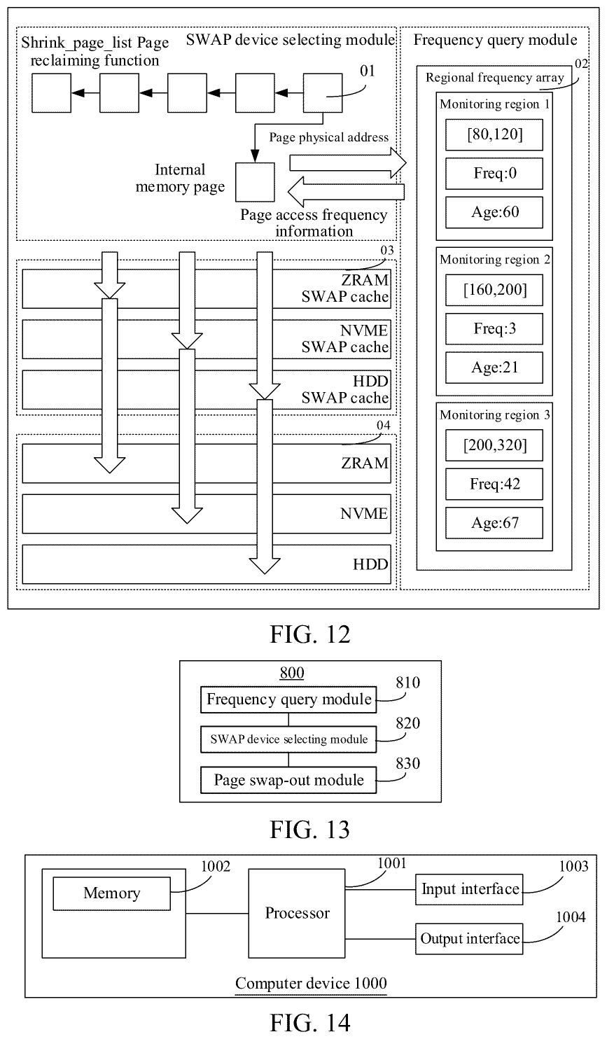

As an example, FIG. 12 is a schematic diagram of an internal memory reclaiming method according to some embodiments. The method is performed by a computer device. For example, the operating system of the computer device is Linux system, including three levels of SWAP devices, for example, ZRAM, NVME, and HDD, and each SWAP device is provided with a corresponding buffer storage area, for example, ZRAM SWAP cache, NVME SWAP cache, and HDD SWAP cache.

In some embodiments, the computer device is provided with a frequency query module and a SWAP device selecting module. The frequency query module is configured to provide a page access frequency of an internal memory page and an age of the page access frequency. The SWAP device selecting module is configured to select SWAP devices.

The page access frequency query module and the SWAP device selecting module are independently implemented in a Linux kernel module. The following describes modules and operations of the internal memory reclaiming method in the embodiments.

Operation 1: In a case of receiving an internal memory reclaiming instruction, determine, based on the page access frequency query module, page access frequency information of an internal memory page 01 to be reclaimed.

In some embodiments, the page access frequency information includes a page access frequency and a frequency age.

In some embodiments, the frequency query module stores regional frequency array 02 corresponding to each monitoring region in the internal memory, regional frequency array 02 includes a start physical address, an end physical address, and access frequency information of each monitoring region, and the access frequency information includes an access frequency and a frequency age.

For example, refer to FIG. 12, the computer device includes monitoring region 1, monitoring region 2, and monitoring region 3. A physical address interval including a start physical address and an end physical address of monitoring region 1 in regional frequency array 02 is [80,120], an access frequency is 0, and a frequency age is 60 (seconds). A physical address interval including a start physical address and an end physical address of monitoring region 2 is [160,200], an access frequency is 3, and a frequency age is 21. A physical address interval including a start physical address and an end physical address of monitoring region 3 is [200,320], an access frequency is 42, and a frequency age is 67.

In some embodiments, a physical address of internal memory page 01 is obtained; based on the start physical address and the end physical address of each monitoring region included in the regional frequency array in the page access frequency query module, binary search is performed on the physical address to determine a target monitoring region to which the physical address belongs; and region access frequency information of the target monitoring region is determined as the page access frequency information of the internal memory page.

Operation 2: Determine, based on the SWAP device selecting module, a target SWAP device matching the page access frequency information from the at least two groups of SWAP devices of the computer device.

In some embodiments, the computer device obtains a partition parameter array based on the SWAP device selecting module; and determines the target SWAP device from the at least two groups of SWAP devices based on the page access frequency information and the partition parameter array.

Each SWAP device of the at least two groups of SWAP devices is preset with a frequency and a frequency age of the SWAP device, which are stored in a partition frequency array.

In some embodiments, the computer device selects, based on the SWAP device selecting module, a frequency of a candidate SWAP device in the partition parameter array, respective frequencies of the at least two groups of SWAP devices having at most one chance as the frequency of the candidate SWAP device; determines the candidate SWAP device as the target SWAP device in a case that the page access frequency is greater than the frequency of the candidate SWAP device; and in a case that the page access frequency is less than or equal to the frequency of the candidate SWAP device, restarts from the operation of selecting a frequency of a candidate SWAP device in the partition parameter array.

In some embodiments, the computer device determines, based on the SWAP device selecting module, speed indication information of a candidate SWAP device in the partition parameter array, the respective speed indication information of the at least two groups of SWAP devices having at most one chance as the speed indication information of the candidate SWAP device; determines the candidate SWAP device as the target SWAP device in a case that the page access frequency is equal to a page access frequency of the candidate SWAP device, and the frequency age is greater than or equal to an age of the candidate SWAP device; and in a case that the page access frequency is not equal to the page access frequency of the SWAP device, and the frequency age is less than or equal to the age of the candidate SWAP device, restarts from the operation of determining speed indication information of a candidate SWAP device in the partition parameter array.

In some embodiments, the computer device obtains, based on the SWAP device selecting module, priorities of the at least two groups of SWAP devices in a case that the target SWAP device matching the page access frequency information is unable to be determined from the at least two groups of SWAP devices based on the page access frequency information; and determines, from SWAP devices with an idle capacity greater than a data amount of the content data stored in the internal memory page, a SWAP device with a highest priority as the target SWAP device in descending order of the priority.

Operation 3: A data storage module in the operating system uninstalls content data stored in the internal memory page to the target SWAP device, to reclaim the internal memory page.

In some embodiments, target buffer storage area 03 corresponding to the target SWAP device is determined; content data stored in internal memory page 01 is cached in target buffer storage area 03; and in a case that the content data exceeds the cache capacity of the target buffer storage area, the content data in the internal memory page is uninstalled to target SWAP device 04, to reclaim internal memory page 01.

For example, the target SWAP device is a ZRAM device. First, the content data stored in internal memory page 01 is cached in ZRAM SWAP cache; and in a case that the content data exceeds a cache capacity of the ZRAM SWAP cache, the content data in internal memory page 01 is uninstalled to the target SWAP device, to reclaim internal memory page 01.

Internal memory compression (ZSWAP) is a virtual internal memory compression feature of the Linux kernel, and may provide internal memory compression write-back cache for an internal memory page to be swapped out. When an internal memory page may be swapped out, in ZSWAP technology, the internal memory page is not swapped out to a SWAP device first, but content data of the internal memory page that may be swapped out is compressed and stored in a dynamically allocated ZSWAP internal memory pool in a random access memory (RAM) of the system. If a size of the dynamically allocated ZSWAP internal memory in the system RAM exceeds a user-defined maximum size during swap-out, or the internal memory pool cannot allocate data that is compressed and stored in the internal memory, ZSWAP may swap out the compressed data stored in the ZSWAP internal memory pool to the SWAP devices according to a least recently used (LRU) principle in LRU hot and cold order. However, if there are a plurality of SWAP devices in the system, ZSWAP selects, based on a user-defined priority of the SWAP device, a target SWAP device for swap-out. A SWAP device with a highest priority is first selected, when the SWAP device with the highest priority is used up, a SWAP device with a second highest priority is selected, and so on.

Due to a compromise between device costs and access performance, in the related art, storage devices are tiered: frequently accessed pages are stored on faster but expensive devices, while infrequently accessed pages are stored on slow and cheap devices, to make the best use of them.

First problem in the related art: In the internal memory pool of ZSWAP technology, internal memory pages to be swapped out are sorted in LRU hot and cold order. However, when the ZSWAP internal memory pool is full or the system internal memory is insufficient, the internal memory pool is moved down to a SWAP device, and selection of the SWAP device is not determined based on cold and hot of the internal memory page and a speed of the SWAP device, which violates the principle of device tiering.

Second problem in the related art: ZSWAP is to have a real SWAP device to operate. In some systems, only ZRAM internal memory compression technology can replace a real hard disk to provide a swap function for the system. In this system environment, ZSWAP cannot work.

The solutions in the embodiments of this application can solve the above problems. The solutions in the embodiments of this application include two main modules: a page access frequency query module and a SWAP device selecting module (swap partition selecting module).

In the related art, a native kernel may check a hot and cold degree of a physical page based on only two bits: PG_active and PG_referenced, and bits of PG_active and PG_referenced of a page that may be swapped out are all zero. Hot and cold information provided by the native kernel is very single, and it is not possible to determine a SWAP device for swap-out based on the single information. The page access frequency query module may provide additional access frequency information for all pages in internal memory physical address space, which provides a premise for solving the first problem. The SWAP device selecting module may select SWAP devices with different speeds for swap-out based on the page access frequency information provided by the page access frequency query module, thereby solving the first problem. In addition, the ZRAM device is the SWAP device in the system, and the solutions in the embodiments of this application may support tiering of only the SWAP device of the ZRAM device in the system, especially when there are a plurality of ZRAM devices with different compression algorithms (at least one of compression rates and compression speeds are different) in the system.

Some embodiments may relate to a frequency query module and a SWAP device selecting module, and original single SWAP cache is expanded into per-SWAP cache.

In some embodiments, when the computer device may reclaim internal memory, page access frequency information of an internal memory page to be reclaimed is first queried in the frequency query module. The SWAP device selecting module calculates which SWAP device is selected for swap-out based on the page access frequency information, and starts to perform cache reclaiming on the internal memory page to be reclaimed. Content data in the internal memory page is first cached in SWAP cache corresponding to the SWAP device. If the SWAP cache is used up, pages in the SWAP cache are moved down to the SWAP device at one time. The following describes the modules in turn.

### 1. Frequency Query Module

The frequency query module may be improved based on a DAMON physical address monitoring framework, and DAMON may monitor cold and hot distribution of global internal memory with very low overheads. DAMON monitors the entire physical address, and dynamically divides the physical address as monitoring regions. A maximum quantity of monitoring regions may be set by a user, which may ensure that monitoring overheads of DAMON have an upper bound. A principle of DAMON is based on sampling: First, a monitoring region that may be monitored is dynamically divided from the entire physical address, and then a pre-sampled address is randomly extracted in each monitoring region. An access flag bit of this pre-sampled address is checked in a next sampling cycle, and is counted on a frequency counter of this monitoring region. After a fixed quantity of times of sampling, each monitoring region may have an access frequency count value. Subsequently, DAMON starts an iteration cycle, to merge monitoring regions with similar access frequencies, and then splits each monitoring region. Then, after a frequency counter of each monitoring region is cleared, a next round of sampling with a fixed quantity of times is started, and the iteration cycle is started when the sampling cycle ends. After a quantity of times of dynamic iteration, it can be finally converged to a case in which page access frequencies of all monitoring regions are similar.

The frequency query module is optimized as follows based on a DAMON physical address monitoring framework, and is independently implemented as a new kernel module.

(1) Support full physical address monitoring: There are many system RAMs in a general system, especially in a NUMA architecture. Now, a DAMON physical address monitoring method is: scanning a system RAM linked list registered in the system, and selecting the largest RAM device for monitoring. This method may be wise in a UMA architecture, but if it is in the NUMA architecture, many physical address ranges that need to be monitored may be lost. Therefore, in some embodiments, a single system RAM monitoring policy is extended to full physical address monitoring.

(2) Establish a regional frequency array and search for, by using the bisection method, page access frequency information corresponding to the internal memory page: during implementation of DAMON, because access regions need to be split and merged dynamically, the access regions are linked in series by using a linked list. Therefore, if a linked list is searched for a corresponding access region based on a physical address of a page, time complexity is O(n). Some embodiments is implemented as follows: After a fixed quantity of times of sampling, each monitoring region may have an access frequency counter. In the iteration cycle, [start physical address, end physical address, access frequency, and frequency age] of each region is dumped and stored into an array. During searching, binary search is performed based on the physical address of the page and [start physical address and end physical address] of an array element, and finally matched [access frequency and frequency age] is returned to a caller.

(3) Read-write lock or RCU protects write access of a regional frequency array and protects SWAP process search access: as mentioned in the foregoing embodiment, the regional frequency array may be modified in the iteration cycle, and the regional frequency array may be searched for during swap-out. This leads to concurrent access, and read access is more frequent than write access. In some embodiments, the read-write lock or RCU is used for protection, which may ensure a concurrent rate of the page access frequency query module.

(4) Other optimization: removing a water mark mechanism of native DAMON physical address monitoring. Page access frequency query may occur at any time of the system and in any remaining free internal memory, which is contrary to the water mark mechanism; removing a schemes mechanism of native DAMON physical address monitoring. The schemes mechanism is originally used for the user to specify some rules and actions, and implement corresponding actions on a monitoring region that meets the rules, such as: reclaiming a monitoring region with a low access frequency. In some embodiments, the page access frequency query module is only used for providing additional page access frequency information for the page, and the schemes mechanism is not needed; and increasing a quantity of DAMON default sampling cycles and a maximum quantity of monitoring regions, and improving accuracy of the page access frequency query module.

The frequency query module is implemented as an independent Linux kernel module, which is easy to load dynamically and does not need to restart the system.

### 2. SWAP Device Selecting Module

The frequency query module provides additional page access frequency information for the page: a page access frequency and a page access frequency age, which may swap out pages with different page access frequencies to SWAP devices with corresponding speeds. The SWAP device selecting module is implemented in the following methods: the user configures matching rules of the SWAP devices started in the operating system, such as specifying a page access frequency and age matching the SWAP device, and an access speed configuration function controlling the SWAP device is determined by using an enable switch. A hook function is inserted into internal memory page swap-out code, and the hook function calls the frequency query module to search for [access frequency information and age] of the internal memory page to be reclaimed. Based on the page access frequency information, the SWAP device selecting module selects which SWAP device cache is to be selected for swap-out. A selection policy is as follows:

(1) The user sets corresponding frequency and age parameters for the SWAP device every time, and enables a frequency selecting function of the SWAP device by using the enable switch. The SWAP device selecting module may sort SWAP devices with the frequency selecting function enabled, which is dynamically stored in an array. A lower frequency value indicates a higher location in the array. If frequency values are the same, refer to an age value, and a greater age value indicates a higher location in the array.

(2) When corresponding [access frequency and frequency age] of the page is queried from the page access frequency query module, the array may be traversed from front to back. When an access frequency of the page exceeds a frequency of a currently traversed array element, a SWAP device corresponding to the array element is selected as the target SWAP device. When the access frequency of the page is equal to the frequency of the currently traversed array element, and a frequency age of the page exceeds an age value of the currently traversed array element, a SWAP device corresponding to the array element is selected as the target SWAP device. Otherwise, a next array element of the array is traversed.

(3) When all elements in the array are traversed, and the corresponding SWAP device still cannot be found, a swapped target SWAP device is selected according to a kernel native SWAP priority policy. The SWAP device selecting module is also implemented as an independent Linux kernel module, which is easy to load dynamically and does not need to restart the system.

### 3. Expand and Optimize Single SWAP Cache

A native SWAP slots cache module is a single SWAP slots cache, and a usage rule of the SWAP device is also sorting based on a priority defined when the user starts the SWAP device. An internal memory page to be swapped out is preferentially swapped out to the SWAP device with the highest priority, and when the SWAP device with the highest priority is used up, it is swapped out to a SWAP device with the second highest priority, and so on. However, slots of the SWAP device are cached in batches (generally 32 slots) in turn in the single SWAP slots cache, and this single cache is not feasible for an uninstalling purpose of a plurality of levels of SWAP devices in the embodiments of this application. For example, when the single cache is caching slots of an NVME device, and a SWAP tiering module may send a cold page to an HDD device, then the single cache is invalid. If the single cache is invalid, it is easy to cause performance bumps.

In some embodiments, the SWAP slots cache module is optimized, and cache is configured for each SWAP device. According to this, a delivered internal memory page is preferentially cached in a corresponding cache, and then washed to the SWAP device at one time in a batch, thereby ensuring performance of concurrent swap-in and swap-out of a plurality of SWAP devices.

In some embodiments, a SWAP device with a corresponding speed is selected for swap-out by using page access frequency information provided based on DAMON physical address monitoring. In the related art, such as idle page tracking and perf mem, additional page access frequency information may be provided. These technologies have the following problems: 1. Lack of lightweight monitoring, and monitoring costs are large; 2. Unable to provide detailed frequency information, and frequency information provided in the idle page tracking technology is single; and perf mem is not implemented in s kernel, so when an internal memory page is swapped out, it is impossible to obtain frequency information provided by perf mem.

In conclusion, some embodiments propose, from an operating system kernel level, a solution of swapping out to a SWAP device with a corresponding speed based on a DAMON physical address monitoring frequency, which is suitable for various operating system scenarios, especially for a cloud scenario. A high-performance SWAP device may be used for increasing system internal memory and improving performance, and may increase a resource utilization rate, improve an oversold rate, and reduce deployment costs.

FIG. 13 is a block diagram of a structure of a computer device according to some embodiments. The computer device includes at least two groups of SWAP devices, and the computer device 800 includes:
a frequency query module 810, configured to determine, in a case of receiving an internal memory reclaiming instruction, page access frequency information of an internal memory page to be reclaimed;
a SWAP device selecting module 820, configured to determine a target SWAP device matching the page access frequency information from the at least two groups of SWAP devices; and
a page swap-out module 830, configured to uninstall content data stored in the internal memory page to the target SWAP device, to reclaim the internal memory page.

In some embodiments, the SWAP device selecting module 820 includes: an information obtaining unit, configured to: obtain respective speed indication information of the at least two groups of SWAP devices, the speed indication information representing an access speed of accessing content data from the SWAP device; and determine the target SWAP device from the at least two groups of SWAP devices based on the page access frequency information and the speed indication information, the target SWAP device having a target access speed, the target access speed matching the page access frequency information.

In some embodiments, the device determining unit is configured to: obtain a partition parameter array, the partition parameter array including the respective speed indication information of the at least two groups of SWAP devices; and determine the target SWAP device from the at least two groups of SWAP devices based on the page access frequency information and the partition parameter array. In some embodiments, the speed indication information of the SWAP device includes the frequency of the SWAP device; and the page access frequency information of the internal memory page includes a page access frequency, and the device determining subunit is configured to: select a frequency of a candidate SWAP device in the partition parameter array, respective frequencies of the at least two groups of SWAP devices having at most one chance as the frequency of the candidate SWAP device; determine the candidate SWAP device as the target SWAP device in a case that the page access frequency is greater than the frequency of the candidate SWAP device; and in a case that the page access frequency is less than or equal to the frequency of the candidate SWAP device, restart from the operation of selecting a frequency of a candidate SWAP device in the partition parameter array.

In some embodiments, the speed indication information of the SWAP device includes: the frequency of the SWAP device and an age of the SWAP device, and the page access frequency information of the internal memory page includes: a page access frequency and a frequency age; and the device determining subunit is configured to: determine speed indication information of a candidate SWAP device in the partition parameter array, the respective speed indication information of the at least two levels of SWAP devices having at most one chance as speed indication information of the candidate SWAP device; determine the candidate SWAP device as the target SWAP device in a case that the page access frequency is equal to a page access frequency of the candidate SWAP device, and the frequency age is greater than or equal to an age of the candidate SWAP device; and in a case that the page access frequency is not equal to the page access frequency of the SWAP device, and the frequency age is less than or equal to the age of the candidate SWAP device, restart from the operation of determining speed indication information of a candidate SWAP device in the partition parameter array.

In some embodiments, the device determining subunit is further configured to: determine the target SWAP device based on priorities of the at least two levels of SWAP devices in a case that the target SWAP device matching the page access frequency information is unable to be determined from the at least two levels of SWAP devices based on the page access frequency information, the priority representing an order of priority of selecting the target SWAP device from the at least two groups of SWAP devices.

In some embodiments, the device determining subunit is further configured to: obtain the priorities of the at least two levels of SWAP devices; and determine, from SWAP devices with an idle capacity greater than a data amount of the content data, a SWAP device with a highest priority as the target SWAP device in descending order of the priority, the idle capacity being a capacity in which the content data is not stored in the SWAP device.

In some embodiments, the at least two levels of SWAP devices have respective buffer storage areas in the computer device; and the page swap-out module 830 is configured to: cache the content data that is stored in the internal memory page in a target buffer storage area, the target buffer storage area being a buffer storage area of the target SWAP device; and uninstall the content data in the internal memory page from the internal memory to the target SWAP device in a case that a total amount of content data cached in the target buffer storage area exceeds a cache capacity of the target buffer storage area.

In some embodiments, the frequency query module 810 includes: an address obtaining unit, configured to obtain a physical address and a regional frequency array of the internal memory page, where the regional frequency array includes region access frequency information of at least one monitoring region, and the monitoring region is a partial address segment in a full physical address of the computer device; and a region searching unit, configured to: search, based on the physical address of the internal memory page, the regional frequency array for a target monitoring region to which the physical address of the internal memory page belongs; and determine region access frequency information of the target monitoring region as the page access frequency information of the internal memory page.

In some embodiments, the regional frequency array further includes a start physical address and an end physical address of the monitoring region, and the region searching unit is configured to: perform binary search on the physical address of the internal memory page based on a respective start physical address and end physical address of the at least one monitoring region, and determine the target monitoring region to which the physical address belongs.

In some embodiments, the apparatus 800 further includes a monitoring region division module, configured to: divide the full physical address of the internal memory to obtain the at least one monitoring region; for a first monitoring region in the at least one monitoring region, perform sampling on a pre-sampled address in the first monitoring region for a fixed quantity of times in a current round based on a set sampling cycle, to obtain a first access frequency of the first monitoring region; after the current round of sampling with a fixed quantity of times is finished, merge n monitoring regions with access frequencies meeting a merging condition, to obtain at least one second monitoring region, n being a positive integer; split the at least one second monitoring region separately to obtain at least one updated monitoring region; and for a first monitoring region in the at least one updated monitoring region, start from the operation of performing sampling on a pre-sampled address in the first monitoring region for a fixed quantity of times in a current round based on a set sampling cycle, to obtain a first access frequency of the first monitoring region, until an iteration number is reached, and each monitoring region in the internal memory is obtained.

The modules of the above computer device may be implemented in whole or in part by software, hardware, and a combination thereof. The modules may be embedded in a processor in a computer device in the form of hardware or independent of the processor in the computer device, and may also be stored in a memory of the computer device in the form of software, so that the processor may invoke and execute corresponding operations of the modules.

An embodiment of this application further provides a computer device. An operating system is installed in the computer device, and the computer device includes: a processor and a memory, the memory having a computer program stored therein; and the processor being configured to execute the computer program in the memory to implement the internal memory reclaiming method according to the foregoing method embodiments.

FIG. 14 is a block diagram of a structure of a computer device according to some embodiments. The computer device 1000 includes a processor 1001 and a memory 1002.

The processor 1001 may include one or more processing cores, such as a 4-core processor and an 8-core processor. The processor 1001 may be implemented in at least one hardware form of digital signal processing (DSP), a field-programmable gate array (FPGA), and a programmable logic array (PLA). The processor 1001 may also include a main processor and a coprocessor. The main processor is a processor configured to process data in an awake state, and is also referred to as a central processing unit (CPU). The coprocessor is a low-power-consumption processor configured to process data in a standby state. In some embodiments, the processor 1001 may be integrated with a graphics processing unit (GPU). The GPU is configured to render and draw content that may be displayed on a display. In some embodiments, the processor 1001 may further include an artificial intelligence (AI) processor. The AI processor is configured to process a computing operation related to machine learning.

The memory 1002 may include one or more computer-readable storage media that may be non-transitory. The memory 1002 may also include a high-speed random access memory, a non-volatile memory, such as one or more disk storage devices and flash storage devices. In some embodiments, the non-transitory computer-readable storage medium in the memory 1002 is configured to store at least one instruction, and the at least one instruction is configured for being executed by the processor 1001 to implement the internal memory reclaiming method provided in the method embodiments of this application.

In some embodiments, the computer device 1000 may further include: an input interface 1003 and an output interface 1004. The processor 1001, the memory 1002, the input interface 1003, and the output interface 1004 may be connected through a bus or a signal cable. Each peripheral device may be connected to the input interface 1003 and the output interface 1004 through the bus, the signal cable, or a circuit board. The input interface 1003 and the output interface 1004 may be configured to connect at least one peripheral device related to input/output (I/O) to the processor 1001 and the memory 1002. In some embodiments, the processor 1001, the memory 1002, the input interface 1003, and the output interface 1004 are integrated on the same chip or circuit board. In some embodiments, any one or two of the processor 1001, the memory 1002, the input interface 1003, and the output interface 1004 may be implemented on a single chip or circuit board. This is not limited in the embodiments of this application.

A person skilled in the art may understand that the structure shown in FIG. 14 constitutes no limitation on the computer device 1000, and the computer device may include more or fewer components than those shown in the figure, or some components may be combined, or a different component deployment may be used.

In some embodiments, a chip is further provided. The chip includes a programmable logic circuit and/or program instructions. When the chip is run on a computer device, the chip is configured to implement the internal memory reclaiming method provided in the foregoing method embodiments.

An embodiment of this application provides a computer-readable storage medium. The computer-readable storage medium has a computer program stored therein, and the computer program is loaded and executed by a processor to implement the internal memory reclaiming method provided in the foregoing method embodiments.

An embodiment of this application provides a computer program product. The computer program product includes computer instructions. The computer instructions are stored in a computer-readable storage medium. A processor obtains the computer instructions from the computer-readable storage medium, so that the processor loads and executes the computer instructions to implement the internal memory reclaiming method provided in the foregoing method embodiments.

A person of ordinary skill in the art may understand that all or some of the operations of some embodiments may be implemented by hardware, or may be implemented by a program instructing relevant hardware. The program may be stored in a computer-readable storage medium. The computer-readable storage medium may be a read-only memory, a magnetic disk, an optical disc, or the like.

A person skilled in the art is to be aware that in the one or more examples, the functions described in the embodiments of this application may be implemented by using hardware, software, firmware, or any combination thereof. When implemented by using software, the functions may be stored in a computer-readable medium or may be used as one or more instructions or code in a computer-readable medium for transferring. The computer-readable medium includes a computer storage medium and a communication medium, where the communication medium includes any medium that enables a computer program to be transmitted from one place to another. The storage medium may be any available medium accessible to a general-purpose or dedicated computer.

What is claimed is:

1. An internal memory reclaiming method, performed by a computer device that comprises at least two groups of SWAP devices, the method comprising:
determining page access frequency information of an internal memory page to be reclaimed based on receiving an internal memory reclaiming instruction;
determining a target SWAP device from the at least two groups of SWAP devices based on the page access frequency information; and
transferring content data stored in the internal memory page to the target SWAP device.

2. The method according to claim 1,
wherein determining a target SWAP device matching the page access frequency information from the at least two groups of SWAP devices comprises:
obtaining speed indication information of the at least two groups of SWAP devices, wherein the speed indication information represents an access speed of accessing content data from the SWAP device; and
determining the target SWAP device from the at least two groups of SWAP devices based on the page access frequency information and the speed indication information, wherein the target SWAP device has a target access speed matching the page access frequency information.

3. The method according to claim 2,
wherein determining the target SWAP device from the at least two groups of SWAP devices based on the page access frequency information and the speed indication information comprises:
obtaining a partition parameter array that comprises the speed indication information of the at least two groups of SWAP devices; and
determining the target SWAP device from the at least two groups of SWAP devices based on the page access frequency information and the partition parameter array.

4. The method according to claim 3,
wherein the speed indication information of the SWAP device comprises a frequency of the SWAP device, and the page access frequency information comprises a page access frequency;
wherein determining the target SWAP device from the at least two groups of SWAP devices based on the page access frequency information and the partition parameter array comprises:
selecting a frequency of a candidate SWAP device in the partition parameter array, wherein each frequency of the at least two groups of SWAP devices has at most one chance as the frequency of the candidate SWAP device;
determining the candidate SWAP device as the target SWAP device, in a case that the page access frequency is greater than the frequency of the candidate SWAP device; and
restarting selecting a frequency of a candidate SWAP device in the partition parameter array, in a case that the page access frequency is less than or equal to the frequency of the candidate SWAP device.

5. The method according to claim 3,
wherein the speed indication information of the SWAP device comprises: a frequency of the SWAP device and an age of the SWAP device;
wherein the page access frequency information of the internal memory page comprises: a page access frequency and a frequency age.

6. The method according to claim 3,
wherein determining the target SWAP device from the at least two groups of SWAP devices based on the page access frequency information and the partition parameter array comprises:
determining speed indication information of a candidate SWAP device in the partition parameter array, wherein the speed indication information of the at least two groups of SWAP devices has at most one chance as the speed indication information of the candidate SWAP device;
determining the candidate SWAP device as the target SWAP device, in a case that the page access frequency is equal to the frequency of the candidate SWAP device and the frequency age is greater than or equal to an age of the candidate SWAP device; and
restarting determining speed indication information of a candidate SWAP device in the partition parameter array, in a case that the page access frequency is not equal to the frequency of the SWAP device and the frequency age is less than or equal to the age of the candidate SWAP device.

7. The method according to claim 1, wherein the method further comprises:
determining the target SWAP device based on priorities of the at least two groups of SWAP devices, in a case that the target SWAP device matching the page access frequency information is unable to be determined from the at least two groups of SWAP devices based on the page access frequency information, wherein the priority represents an order of selecting the target SWAP device from the at least two groups of SWAP devices.

8. The method according to claim 7,
wherein the determining the target SWAP device based on priorities of the at least two groups of SWAP devices comprises:
obtaining the priorities of the at least two groups of SWAP devices; and
determining, from among SWAP devices with an idle capacity greater than a data amount of the content data stored in the internal memory page, a SWAP device with a highest priority as the target SWAP device in descending order of the priority, wherein the idle capacity represents available capacity in the SWAP device where content data is not stored.

9. The method according to claim 1,
wherein the at least two groups of SWAP devices have buffer storage areas in the computer device;
wherein transferring content data stored in the internal memory page to the target SWAP device comprises:
caching the content data in a target buffer storage area, wherein the target buffer storage area is a buffer storage area that is configured for the target SWAP device; and
transferring the content data from the internal memory to the target SWAP device, in a case that a total amount of content data that is stored in the target buffer storage area exceeds a cache capacity of the target buffer storage area.

10. The method according to claim 1,
wherein the determining page access frequency information of an internal memory page to be reclaimed comprises:
obtaining a physical address and a regional frequency array of the internal memory page, wherein the regional frequency array comprises region access frequency information of at least one monitoring region, and the monitoring region is a partial address segment in a full physical address of the internal memory;
searching, based on the physical address of the internal memory page, the regional frequency array for a target monitoring region; and
determining region access frequency information of the target monitoring region as the page access frequency information of the internal memory page.

11. The method according to claim 10,
wherein the regional frequency array further comprises a start physical address and an end physical address of the monitoring region;
wherein searching, based on the physical address of the internal memory page, the regional frequency array for a target monitoring region comprises:
performing binary search on the physical address of the internal memory page based on a start physical address and an end physical address of the at least one monitoring region, and determining the target monitoring region to which the physical address belongs.

12. The method according to claim 10, wherein the method further comprises:
dividing the full physical address of the internal memory;
performing sampling on a pre-sampled address in a first monitoring region for a fixed quantity of times in a current round based on a set sampling cycle;
merging n monitoring regions with access frequencies that meet a merging condition based on the current round of sampling with a fixed quantity of times finishing, wherein n is a positive integer;
splitting the at least one second monitoring region; and
starting performing sampling on a pre-sampled address in the first monitoring region for a fixed quantity of times in a current round based on a set sampling cycle until an iteration number is reached, and each monitoring region in the internal memory is obtained.

13. An internal memory reclaiming apparatus, comprising:
at least one memory configured to store computer program code; and
at least one processor configured to read the program code and operate as instructed by the program code, the program code comprising:
determining code configured to cause at least one of the at least one processor to determine page access frequency information of an internal memory page to be reclaimed based on receiving an internal memory reclaiming instruction, and determine a target SWAP device from the at least two groups of SWAP devices based on the page access frequency information; and
transferring code configured to cause at least one of the at least one processor to transfer content data stored in the internal memory page to the target SWAP device.

14. The apparatus according to claim 13,
wherein the determining code is further configured to cause at least one of the at least one processor to:
obtain speed indication information of the at least two groups of SWAP devices, wherein the speed indication information represents an access speed of accessing content data from the SWAP device; and
determine the target SWAP device based on the page access frequency information and the speed indication information, wherein the target SWAP device has a target access speed matching the page access frequency information.

15. The apparatus according to claim 14,
wherein the determining code is further configured to cause at least one of the at least one processor to:
obtain a partition parameter array that comprises the speed indication information of the at least two groups of SWAP devices; and
determine the target SWAP device based on the page access frequency information and the partition parameter array.

16. The apparatus according to claim 15,
wherein the speed indication information of the SWAP device comprises a frequency of the SWAP device, and the page access frequency information comprises a page access frequency;
wherein the determining code is further configured to cause at least one of the at least one processor to:
select a frequency of a candidate SWAP device in the partition parameter array, wherein each frequency of the at least two groups of SWAP devices has at most one chance as the frequency of the candidate SWAP device;
determine the candidate SWAP device as the target SWAP device if the page access frequency is greater than the frequency of the candidate SWAP device; and
restart selecting a frequency of a candidate SWAP device in the partition parameter array if the page access frequency is less than or equal to the frequency of the candidate SWAP device.

17. The apparatus according to claim 15,
wherein the speed indication information of the SWAP device comprises a frequency of the SWAP device and an age of the SWAP device;
wherein the page access frequency information of the internal memory page comprises a page access frequency and a frequency age.

18. The apparatus according to claim 15,
wherein the determining code is further configured to cause at least one of the at least one processor to:
determine speed indication information of a candidate SWAP device in the partition parameter array, wherein the speed indication information of the at least two groups of SWAP devices has at most one chance as the speed indication information of the candidate SWAP device;
determine the candidate SWAP device as the target SWAP device, in a case that the page access frequency is equal to the frequency of the candidate SWAP device and the frequency age is greater than or equal to an age of the candidate SWAP device; and
restart determining speed indication information of a candidate SWAP device in the partition parameter array, in a case that the page access frequency is not equal to the frequency of the SWAP device and the frequency age is less than or equal to the age of the candidate SWAP device.

19. The apparatus according to claim 13,
wherein the determining code is further configured to cause at least one of the at least one processor to:
determine the target SWAP device based on priorities of the at least two groups of SWAP devices, in a case that the target SWAP device matching the page access frequency information is unable to be determined from the at least two groups of SWAP devices based on the page access frequency information, wherein the priority represents an order of selecting the target SWAP device from the at least two groups of SWAP devices.

20. A non-transitory computer-readable storage medium, storing computer code which, when executed by at least one processor, causes the at least one processor to at least:
determine page access frequency information of an internal memory page to be reclaimed based on receiving an internal memory reclaiming instruction, and determine a target SWAP device from the at least two groups of SWAP devices based on the page access frequency information; and
transfer content data stored in the internal memory page to the target SWAP device.
